(19) United States
(12) Patent Application Publication
(10) Pub. No.: US 2004/0150267 A1
(43) Pub. Date: Aug. 5, 2004

(54) Power supply with integrated DC supply for peripheral devices and universal power cable

(76) Inventor: Gary W. Ferguson, Burnaby (CA)

Correspondence Address: TREXLER, BUSHNELL, GIANGIORGI,, BLACKSTONE & MARR, LTD., 105 WEST ADAMS STREET, SUITE 3600, CHICAGO, IL, 60603, US

(21) Appl. No.: 10/758,730

(22) Filed: Jan. 16, 2004

Related U.S. Application Data
(60) Provisional application No. 60/443,766, filed on Jan. 30, 2003.

(51) Int. Cl. H02J 1/00; H02J 3/00

(52) U.S. Cl. 307/70; 307/71

(57) ABSTRACT

A power supply with integrated DC supply for peripheral devices, comprises a power conditioner to convert AC electrical power to DC, and to regulate the DC power to produce a plurality of DC voltages, and receptacles for plugging in to receive said DC voltages. A step-down transformer and a receptacle for lowered-voltage AC power is described. Additionally, a universal cable is described, which carries a variety of DC or lowered voltage AC power and mates with the power supply; the cable can be daisy-chained to plug in several devices to the power supply to tap the variety of DC voltages and lowered-voltage AC power.

### CROSS-REFERENCE

This patent application claims the benefit of domestic priority of U.S. Provisional Application Serial No. 60/443,766, filed on Jan. 30, 2004.

### BACKGROUND OF THE INVENTION

This invention relates to the field of power supply to electrical devices. AC and DC power are utilized not only by computers, but by a growing number of related peripheral devices. Wide adaptation of communication standards such as IEEE 1394 (firewire) and USB make the use of temporary device connections such as digital cameras, scanners, speakers, external optical disks, network hubs, routers, audio mixers, uninterrupted power supplies, etc., more common. However, many of these peripheral devices require power. Accordingly, power distribution bars are evident in almost every computer installation. Typically, the peripheral devices require the use of DC power, and accordingly are sold with power transformers or power conditioners, which may include DC regulation. (These devices are commonly sold with an accessory labeled a “transformer”, which converts household electricity, 115-120 V AC at 60 Hz in the United States, to the lower voltage DC used by the peripheral device. These accessories, however, perform functions additional to conversion of an AC current from one voltage to a second voltage. Accordingly, as used herein, “power conditioner” means a device comprising any combination of transformers, rectifiers, regulators, and/or control circuitry that converts AC electrical current either to AC current at a different voltage or to DC electrical current at the same or a different voltage.) Moreover, many devices peripheral to a computer, such as video cameras, are used completely independently of the computer. These devices still need DC power, but must connect to household AC power either during use or for battery charging.

Companies in the power supply industry have recognized the growing need and desire to connect peripheral devices and have responded to market need in a number of ways. Today, power distribution bars and battery back-up power systems that provide uninterrupted power often include power outlets that are engineered and spaced in a manner to accept plug-in transformers or similar power conditioners to provide low voltage AC or DC power.

Although there are a limited number of DC voltages commonly used in peripheral devices, the situation is made somewhat more complex by the need to select the polarity of these connections.

In general, power supplies are one of the least reliable components in computers and other electrical equipment. Safety recalls for transformers, battery chargers and other products are not uncommon. Cost plays a factor in designing small power transformers to provide DC voltage. Higher rated transformers could adapt relatively easily to the increased needs for DC voltage, thereby eliminating the need for more transformers and other components. Such inclusion could also simplify system installation and device connection. Accordingly, these improvements require a means to connect a peripheral device requiring a DC voltage to the power supply. It is therefore an object of the present invention to improve safety by limiting the number of transformers required to operate peripheral devices. It is a further object to reduce the amount of equipment needed to power peripheral devices. It is a further object to provide a universal means of connecting peripheral devices to a power supply.

### BRIEF SUMMARY OF THE INVENTION

The present invention is an AC power supply that also provides at least one DC voltage or low voltage AC power outlet intended to power a peripheral device. In some embodiments, the power cable carries only the required voltage and provides low voltage AC or DC power via a conventional connector plug. In another embodiment the power cable has universal connectors and carries more than one AC or DC voltage level or combination thereof. The peripheral device taps into the required voltage. Accordingly, one or more levels may be passed on to chained devices to minimize and simplify meeting and distributing power requirements. For example, 15 volts AC, 12 volts DC and 5 volts DC may be carried on a single universal cable. Device one may tap 12 volts DC, while an additional connector provided on device one or a split connector on the universal cable may allow device two to be daisy chained for DC power. In other embodiments, the power supply of the present invention is part of a battery back-up unit or is part of a computer. In another embodiment, the DC connector provides power of a particular polarity.

### BRIEF DESCRIPTION OF THE SEVERAL VIEWS OF THE DRAWINGS

FIG. 1a shows a typical computer and peripheral devices with power supply as known in the prior art.

FIG. 1b shows a power supply of a computer with peripheral devices of an embodiment of the present invention.

FIG. 2a shows a power distribution bar as known in the prior art.

FIG. 2b shows a power distribution bar of an embodiment of the present invention.

FIG. 3a shows a battery back-up power distribution unit as known in the prior art.

FIG. 3b shows a battery back-up power distribution unit of an embodiment of the present invention.

FIG. 3c shows an alternate embodiment of a battery back-up power distribution unit of the present invention with a universal mating device connector.

FIG. 4a shows a universal cable of the present invention.

FIG. 4b shows a mating device connector to the universal cable of the present invention.

FIG. 5 shows an example of the present invention employed in daisy-chained configuration.

### DETAILED DESCRIPTION OF THE INVENTION

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described herein.

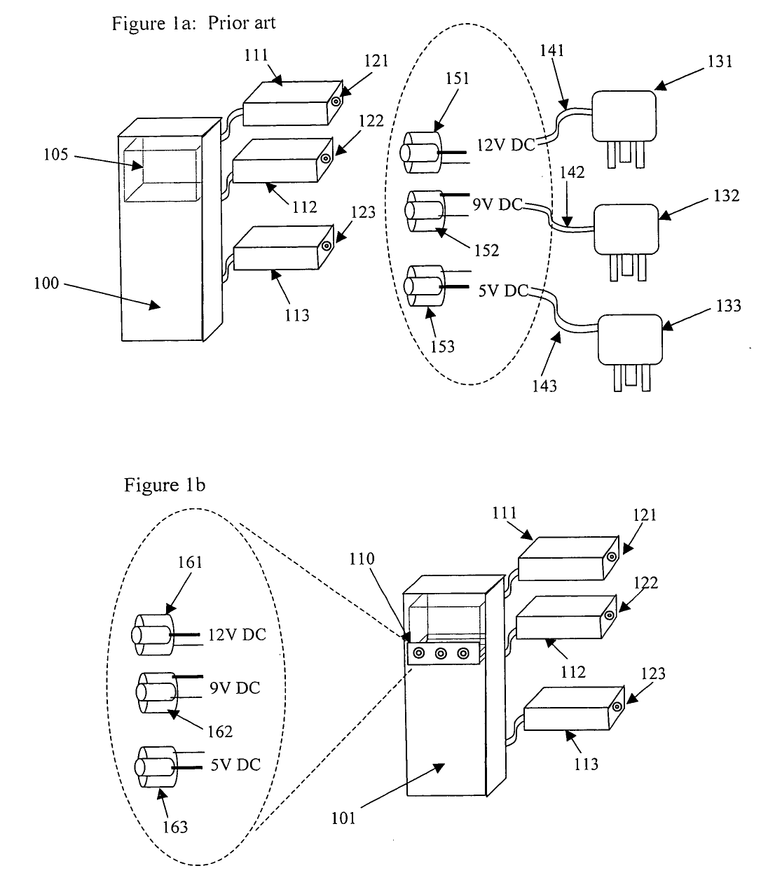

FIG. 1a shows a typical computer 100 with power supply 105. Peripheral devices illustrated include, as examples, an external DVD burner 111, an audio mixer 112, and a network hub 113. These peripheral devices may require, in addition to different voltages, different polarities. For example the DVD burner 111 may require 12 volts DC with a positive inner contact; the audio mixer 112 may require nine volts DC with the positive on the outer contact sleeve of the connector plug; the network hub 113 may require five volts DC. The power connectors for devices for devices 111, 112, 113 are identified respectively as 121, 122, and 123. The mating connectors are shown in magnified view, and are identified as respectively as 151, 152, and 153. In the prior art each peripheral device typically used its own transformer and circuitry for DC power: Plug-in transformer 131 with DC voltage regulator circuit connects to cable 141 which terminated at connector plug 151 shown in expanded view to mate with the power connector 121 of DVD burner 111 thus providing the required 12 volts. Similarly, separate DC transformers 132, 133, with corresponding cables 142, 143, terminate in connector plugs 152 and 153 as shown in expanded view to mate with peripheral device connectors for the audio mixer 112 and network hub 113.

FIG. 1b shows a computer 101 of one embodiment of the present invention having improved computer power supply 110 having transformer and additional voltage regulator circuitry to supply DC power for peripheral devices such as an external DVD burner 111, an audio mixer 112, and a network hub 113. As illustrated, three different DC voltages, with desired polarities, are supplied for the three peripheral devices. Any number of DC connectors with desired polarity can be used and may be combined with low voltage AC supplies from the same transformer in computer power supply 110, or an additional transformer may be incorporated specifically to provide for external devices. In this instance, the three external transformers 131, 132, and 133 as discussed in association with FIG. 1a may be eliminated. The power connectors 121, 122, and 123 of the peripheral devices 121, 122, and 123, respectively, connect directly into mating connectors 161, 162, and 163 provided by the power supply 110, eliminating the need for three separate, bulky transformers.

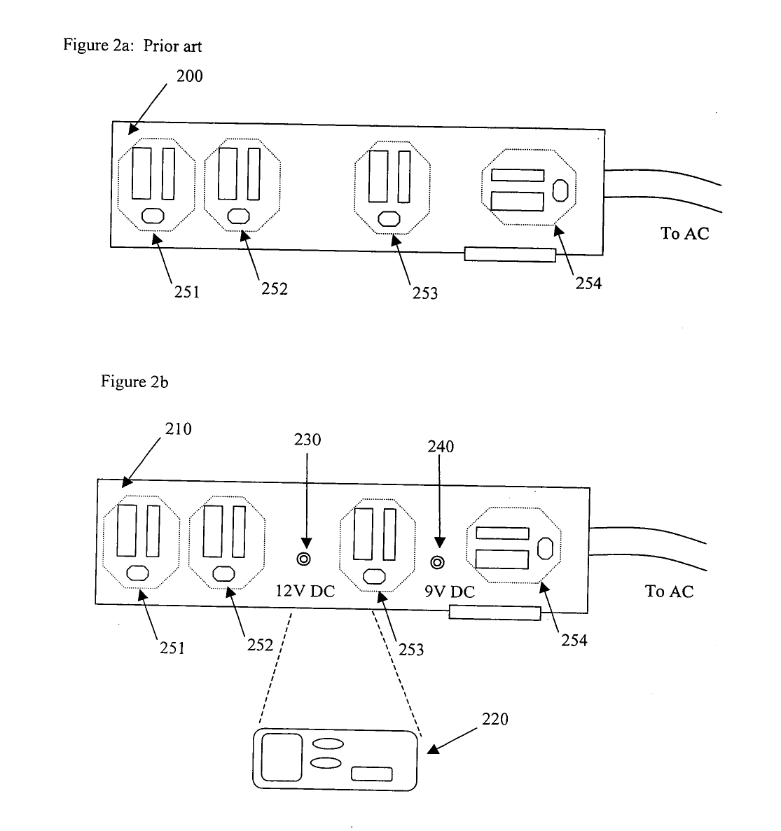

FIG. 2a shows a power distribution bar 200 of another embodiment of the present invention, having four AC power receptacles 251, 252, 253, and 254, as is known in the prior art. Receptacles 253 and 254 are further differentiated by the provision of spacing to accommodate power transformers, as required or desired. Power distribution bar 200 receives AC voltage, such as the 60 Hz, 110 volt power commonly used in North America, and distributes it to the four AC power receptacles. Different size prongs for polarity and third prongs for grounding may be used, as is well known in the art. Different voltages and frequency, as well as different prong sizes and orientation, are used in other localities.

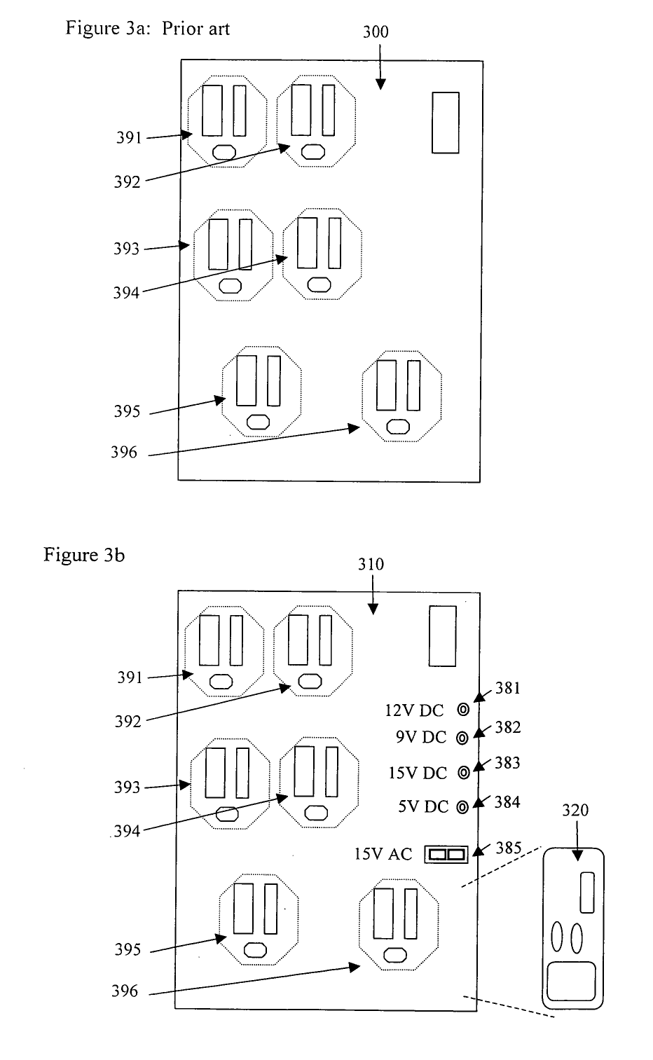

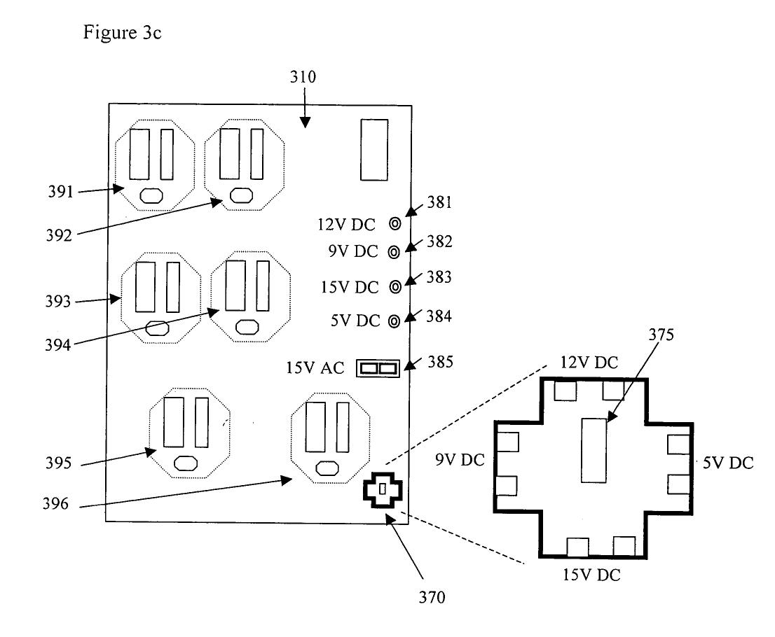

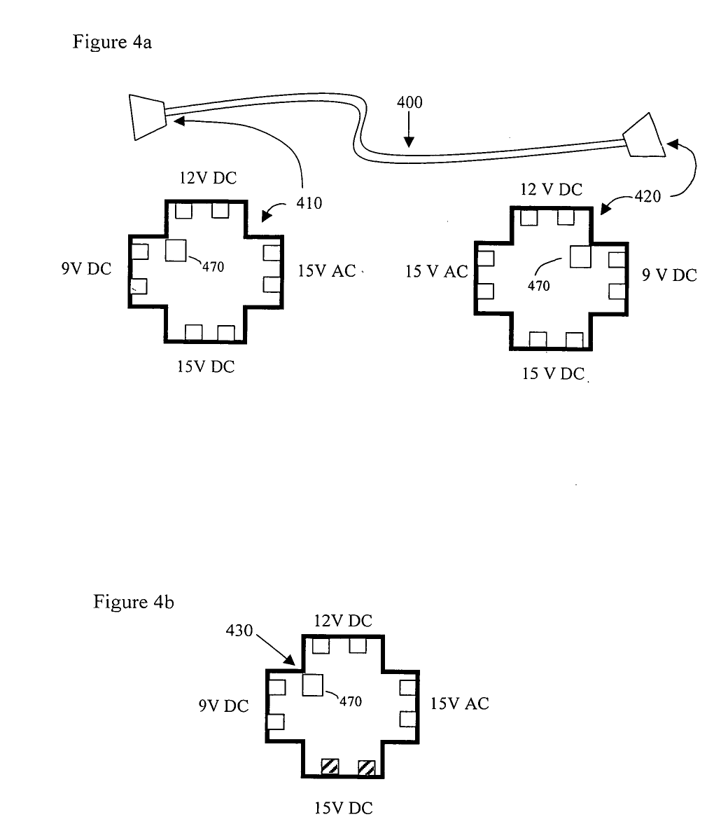

FIG. 2b shows a power distribution bar 210 of the present invention, also having four AC power receptacles 251-254. Internal step down transformer and DC voltage regulator circuitry 220 transform and regulate the AC power supply in a known way to provide convenient voltage levels. In the illustrated example, internal step-down transformer and DC voltage regulator circuitry 220 provides nine volts DC via DC receptacle identified as 230, and 12 volts DC in a DC receptacle identified as 240. Further DC receptacles at various voltages or low voltage AC may be provided as desired. These DC receptacles may also vary the polarity of the DC voltages provided. Other embodiments provide access to a plurality of DC voltages via a single connector plug, as described further in connection with FIGS. 3c, 4a, and 4b.

FIG. 3a shows a battery back-up power distribution unit 300 with AC power receptacles 391, 392, 393, 394, 395, and 396, as is known in the prior art. Additional space is provided for receptacles 395 and 396, which may be provided in this configuration to facilitate the use of plug-in transformers.

FIG. 3b shows a battery back-up power distribution unit 310 of the present invention with DC supplies for some common DC voltages along with a low voltage AC outlet. The unit 310 is an uninterruptible power supply, as is well known in the art, but with the integrated DC supply of the present invention. Accordingly, one or more DC peripheral devices may have battery back-up as required or desired, in addition to battery-back-up for the AC devices connected to AC power receptacles 391-396. Internal circuitry 320 provides, for example, in a way well known in the art, low voltage AC directed to power outlet 385, along with illustrated DC power of 12V, 9V, 15V and 5V with corresponding DC power receptacles further identified respectively as 381, 382, 383, and 384. As discussed above, DC power can also be provided at either, or both polarities.

Internal changes to the distribution unit 310 may include a multi-tap transformer or one with extended ratings and taps for direct adaptation to the innovations herein, including provision of low voltage AC (such as 15V AC provided via receptacle 385) and regulated DC voltages (such as those provided via receptacles 381-384). Such low voltage AC may be used directly by an external device such as those discussed in association with FIG. 1a and 1b or this AC power may be further conditioned or be used for generating DC power within an external device.

FIG. 3c shows another embodiment of the present invention where DC mating device connector 370 provides power connector pins that supply a plurality of voltages. Rather than having four separate DC voltage receptacles (381-384) as were also illustrated in FIG. 3b, a DC mating device connector 370 as illustrated provides 5V, 9V, 12V, and 15 volts DC, carried on separate pairs of wires. A single universal cable 400, as discussed below, couples to mating device connector 370 and carries, simultaneously, DC power at a plurality of voltages, in this example, four different voltages. (Or, the universal cable 400 could carry a plurality of low voltage AC or DC voltages of desired polarity.) A peripheral device connected to this universal cable 400 only taps that voltage it requires. Connector alignment pin 375 may be used to provide cable orientation. Alternatively, a distinctive shape, such as a two-dimensional key, can achieve proper alignment.

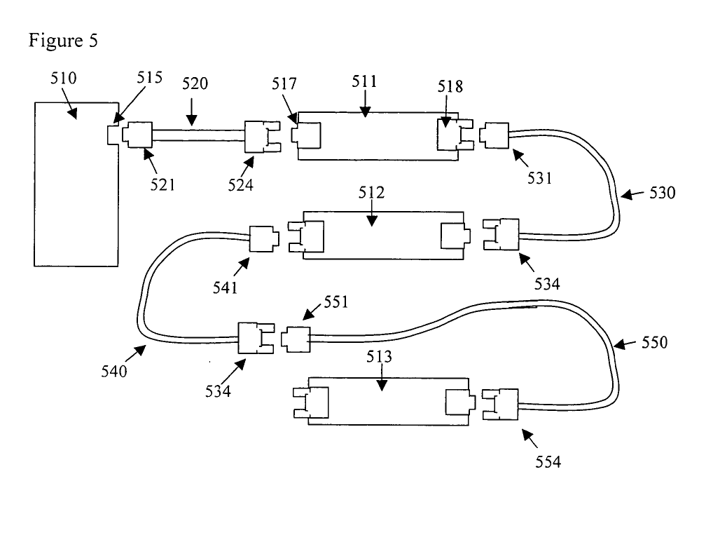

As will be further discussed in association with FIGS. 4a, 4b and FIG. 5, it may be desirable to provide a number of common voltages with a first peripheral device tapping in at the required pins for the voltage required for that device, and one or more other peripheral devices daisy-chaining and tapping into the DC voltage required for each device. Accordingly, two or more peripheral devices can all draw power from a single mating device connector such as 370. Alternatively, one of the pairs of wire can carry AC voltage, either full voltage or step-downed voltage as may be required.

Please note that the mating device connector 370 as illustrated in FIG. 3c can also be used in the computer power supply 110 of FIG. 1b, the power bar of FIG. 2b, or the battery back up unit 310 of FIG. 3b.

FIG. 4a shows a universal cable 400 of the present invention with connector ends 410 and 420. While these ends could be both male or both female, they are illustrated as male 410 and female 420 as mirror images to further allow them to be connected serially. The pin configurations shown are functional representations. Standardized DC pin placement and connectors could simplify specifications for connecting peripheral devices. For example, an international consortium could evolve cable specifications including size, shape, length, current capacity, configuration(s), connections, desired voltages, electrical shielding requirements etc. Whatever the specifications, the mating device connectors on the peripheral devices must match the corresponding end of the universal cable 400.

In the embodiment illustrated in FIG. 4a, the universal cable 400 carries 5V DC, 12V DC, 15 volts DC power and 15 volts AC power. The male end 410 of the cable 400 plugs into the mating device connector such as 370 as shown in FIG. 3c, which could also be on a power supply such as 110 (FIG. 1b), a power bar such as 210 (FIG. 2b), or a battery back up unit such as 310 (FIG. 3c). The female end 420 attaches to a peripheral device such as male mating device connector 430 illustrated in FIG. 4b. An alignment pin 470 ensures that female end 420 can only be inserted into the mating device connector 430 in one orientation, so that the voltages match up. In this embodiment, the peripheral device's mating device connector 430 only taps into the 15 volt DC power supply. The tapped voltage and untapped voltages may be directed to another connector on the peripheral device to allow daisy-chaining as will be further discussed in association with FIG. 5. However, the same universal cable 400 would be used for other peripheral devices that would similarly tap into those power supplies, as required. Accordingly, a user may only need to carry one power supply and one universal cable to operate several peripheral devices.

In another embodiment of the universal cable 400 of the present invention, a plurality of common voltages is brought into the peripheral device, as set forth above. The mating device connector 430 of the peripheral device taps into the pins for the necessary voltage, and allows all four voltages carried by the cable 400 to pass through, as illustrated in FIG. 4b. A second universal cable 401, substantially the same as the universal cable 400, can then tap into a second mating device connector 440 on the peripheral device, that second mating device connector 440 being configured like the female end 420 of the universal cable 400 (and therefore not separately illustrated). The male end 410 of the second universal cable 401 taps into the second mating device connector 440 and carries all four available voltages through to the female end 420 of the second universal cable 401, which can then plug into a second peripheral device that will tap whichever voltage it requires. In this manner, peripheral devices can be daisy-chained together and take up only one power receptacle such as 370 shown in FIG. 3c.

FIG. 5 shows another embodiment of the universal cable of the present invention as discussed in association with FIG. 4b, illustrating three peripheral devices (511, 512, 513) daisy-chained to a power supply 510 within a either a computer, power bar, or battery back up unit, providing a mating device connector such as 370 described in association with FIG. 3c. The peripheral devices could have power requirements such as those described for the DVD burner 111, the audio mixer 112, and network hub 113 described in association with FIGS. 1a and 1b.

A first universal cable 520 with male end 521 mates to, in this instance, female power supply connector 515. The female end 524 of universal power distribution cable 520 connects with male mating connector 517 on peripheral device 511. Device 511 taps into its power needs (or simply pass these through) providing further access for additional universal cable 530. In similar manner device 512 is chained power via universal power distribution cable 530. To further illustrate these principles, device 513 receives its power via serially connected universal cables 540 and 550 with mating cable and device connectors. In this instance all pins are reproduced allowing power to be daisy-chained to simplify device connections. Accordingly, each device taps into its required power needs.

While preferred embodiments of the present invention are shown and described, it is envisioned that those skilled in the art may devise various modifications of the present invention without departing from the spirit and scope of the appended claims.

I claim:

1. A power distribution apparatus, comprising:
a plug adapted to receive an AC power supply,
at least one AC power receptacle coupled to said plug,
a power conditioner coupled to said plug to convert said AC power supply to a DC power supply and to regulate said DC power supply to at least one DC voltage, and
at least one DC power receptacle coupled to said power conditioner.

2. The apparatus of claim 1, wherein said at least one DC voltage comprises a plurality of DC voltages and said at least one DC power receptacle comprises a plurality of DC power receptacles.

3. The apparatus of claim 2, wherein at least one of said plurality of DC power receptacles is adapted to a first polarity and at least one of said plurality of DC power receptacles is adapted to a second polarity.

4. The apparatus of claim 1 wherein said AC power supply is at a first voltage and said power conditioner further produces AC power at a second voltage, and said apparatus further comprises at least one AC power receptacle coupled to said power conditioner.

5. A battery back-up apparatus, comprising:
an uninterruptible power supply unit providing an AC power supply,
at least one AC power receptacle coupled to said unit,
a power conditioner coupled to said unit to convert said AC power supply to a DC power supply and to regulate said DC power supply to at least one DC voltage, and
at least one DC power receptacle coupled to said power conditioner.

6. The apparatus of claim 5, wherein said at least one DC voltage comprises a plurality of DC voltages and said at least one DC power receptacle comprises a plurality of DC power receptacles.

7. The apparatus of claim 6, wherein at least one of said plurality of DC power receptacles is adapted to a first polarity and at least one of said DC power receptacles is adapted to a second polarity.

8. The apparatus of claim 5 wherein said AC power supply is at a first voltage and said power conditioner further produces AC power at a second voltage, and said apparatus further comprises at least one AC power receptacle coupled to said power conditioner.

9. A computer power supply, comprising:
a computer,
a plug coupled to said computer and adapted to receive an AC power supply,
a power conditioner coupled to said plug to convert said AC power supply to a DC power supply and to regulate said DC power supply to at least one DC voltage,
at least one DC power receptacle coupled to said power conditioner.

10. The apparatus of claim 10, wherein said at least one DC voltage comprises a plurality of DC voltages and said at least one DC power receptacle comprises a plurality of DC power receptacles.

11. The apparatus of claim 9, wherein at least one of said plurality of DC power receptacles is adapted to a first polarity and at least one of said plurality of DC power receptacles is adapted to a second polarity.

12. The apparatus of claim 1 wherein said AC power supply is at a first voltage and said power conditioner further produces AC power at a second voltage, and said apparatus further comprises at least one AC power receptacle coupled to said power conditioner.

13. A universal power cable, comprising:
a cable comprising a plurality of pairs of conducting wires and having a first end and a second end,
a first cable end connected to said first end and comprising a plurality of receptacles corresponding to and coupled to said plurality of pairs of conducting wires, and
a second cable end connected to said second end and comprising a plurality of receptacles corresponding to and coupled to said plurality of pairs of conducting wires.

14. The cable of claim 13, further comprising a first connector alignment pin in said first cable end and a second connector alignment pin in said second cable end, whereby said first cable end and said second cable end can mate in a single orientation.

15. The cable of claim 13, wherein said first cable end has a first shape and said second cable end has a second shape complementary to said first shape, wherein said first cable end and said second cable end can mate in a single orientation.

16. A power distribution apparatus, comprising:
a plug adapted to receive an AC power supply,
at least one AC power receptacle coupled to said plug,
a power conditioner coupled to said plug to convert said AC power supply to a DC power supply and to regulate said DC power supply to a plurality of DC voltages; and
a mating device connector comprising a plurality of DC power receptacles coupled to and corresponding to said plurality of DC voltages.

17. The apparatus of claim 16, wherein at least one of said plurality of DC power receptacles is adapted to a first polarity and at least one of said plurality of DC power receptacles is adapted to a second polarity.

18. The apparatus of claim 16, further comprising a connector alignment pin in said mating device connector.

19. The apparatus of claim 16, wherein said mating device connector has an alignment shape.

20. The apparatus of claim 16 wherein said AC power supply is at a first voltage and said power conditioner further produces AC power at a second voltage, and said apparatus further comprises at least one lower-voltage AC power receptacle coupled to said power conditioner.

21. The apparatus of claim 20, wherein said mating device connector further comprises said at least one lower-voltage AC power receptacle.

22. A battery back-up apparatus, comprising:
an uninterruptible power supply unit providing an AC power supply,
at least one AC power receptacle coupled to said unit,
a power conditioner coupled to said unit to convert said AC power supply to a DC power supply and to regulate said DC power supply to a plurality of DC voltages,
a mating device connector comprising a plurality of DC power receptacles coupled to and corresponding to said plurality of DC voltages.

23. The apparatus of claim 22, wherein at least one of said plurality of DC power receptacles is adapted to a first polarity and at least one of said plurality of DC power receptacles is adapted to a second polarity.

24. The apparatus of claim 22, further comprising a connector alignment pin in said mating device connector.

25. The apparatus of claim 22, wherein said mating device connector has an alignment shape.

26. The apparatus of claim 22 wherein said AC power supply is at a first voltage and said power conditioner further produces AC power at a second voltage, and said apparatus further comprises at least one lower-voltage AC power receptacle coupled to said power conditioner.

27. The apparatus of claim 26, wherein said mating device connector further comprises said at least one lower-voltage AC power receptacle coupled to said power conditioner.

28. A computer power supply, comprising:
a computer,
a plug coupled to said computer and adapted to receive an AC power supply,
a power conditioner coupled to said plug to convert said AC power supply to a DC power supply and to regulate said DC power supply to a plurality of DC voltages,
a mating device connector comprising a plurality of DC power receptacles coupled to and corresponding to said plurality of DC voltages.

29. The apparatus of claim 28, wherein at least one of said plurality of DC power receptacles is adapted to a first polarity and at least one of said DC power receptacles is adapted to a second polarity.

30. The apparatus of claim 28, further comprising a connector alignment pin in said mating device connector.

31. The apparatus of claim 28, wherein said mating device connector has an alignment shape.

32. The apparatus of claim 28 wherein said AC power supply is at a first voltage and said power conditioner further produces AC power at a second voltage, and said apparatus further comprises at least one lower-voltage AC power receptacle coupled to said power conditioner.

33. The apparatus of claim 32, wherein said mating device connector further comprises said at least one lower-voltage AC power receptacle coupled to said power conditioner.

34. A power distribution apparatus for supplying power to at least one peripheral device, comprising:
a plug adapted to receive an AC power supply,
at least one AC power receptacle coupled to said plug,
a power conditioner coupled to said plug to convert said AC power supply to a DC power supply and to regulate said DC power supply to a plurality of DC voltages,
a mating device connector comprising a plurality of DC power receptacles coupled to said DC power supply and corresponding to said plurality of DC voltages, and
a power cable, comprising
a cable comprising a plurality of pairs of conducting wires and having a first end and a second end, wherein said plurality of pairs of conducting wires correspond to said plurality of DC voltages,
a first cable end connected to said first end and comprising a plurality of receptacles corresponding to and coupled to said plurality of pairs of conducting wires, said first cable end adapted to couple to said mating device connector, and
a second cable end connected to said second end and comprising a plurality of receptacles corresponding to and coupled to said plurality of pairs of conducting wires, said second end adapted to fit a peripheral device.

35. The apparatus of claim 34, wherein at least one of said plurality of DC power receptacles is adapted to a first polarity and at least one of said plurality of DC power receptacles is adapted to a second polarity

36. The apparatus of claim 34, further comprising a connector alignment pin in said mating device connector and a connector alignment pin in said first end, wherein said first end aligns with said mating device connector.

37. The apparatus of claim 34, wherein said mating device connector has a first alignment shape and said first end has a second alignment shape complementary to said first alignment shape, wherein said first end aligns in said mating device connector.

38. The apparatus of claim 34 wherein said AC power supply is at a first voltage and said power conditioner further produces AC power at a second voltage, and said apparatus further comprises at least one lower-voltage AC power receptacle coupled to said power conditioner.

39. The apparatus of claim 38, wherein said mating device connector further comprises at least one of said at least one lower-voltage AC power receptacle and said power cable further comprises at least one pair of AC conducting wires corresponding to said at least one of said at least one lower-voltage AC power receptacle, said first cable end further comprises a receptacle corresponding to and coupled to said at least one pair of AC conducting wires, and said second cable end further comprises a receptacle corresponding to and coupled to said at least one pair of AC conducting wires.

40. A battery back-up apparatus for providing back-up power to at least one peripheral device, comprising:
an uninterruptible power supply unit providing an AC power supply,
at least one AC power receptacle coupled to said unit,
a power conditioner coupled to said unit to convert said AC power supply to a DC power supply and to regulate said DC power supply to a plurality of DC voltages,
a mating device connector comprising a plurality of DC power receptacles coupled to and corresponding to said plurality of DC voltages, and
a power cable, comprising
a cable comprising a plurality of pairs of conducting wires and having a first end and a second end, wherein said plurality of pairs of conducting wires correspond to said plurality of DC voltages,
a first cable end connected to said first end and comprising a plurality of receptacles corresponding to and coupled to said plurality of pairs of conducting wires, said first cable end adapted to couple to said mating device connector, and
a second cable end connected to said second end and comprising a plurality of receptacles corresponding to and coupled to said plurality of pairs of conducting wires, said second end adapted to fit the peripheral device.

41. The apparatus of claim 40, wherein at least one of said plurality of DC power receptacles is adapted to a first polarity and at least one of said DC power receptacles is adapted to a second polarity.

42. The apparatus of claim 40, further comprising a connector alignment pin in said mating device connector and a connector alignment pin in said first end, wherein said first end aligns with said mating device connector.

43. The apparatus of claim 40, wherein said mating device connector has a first alignment shape and said first end has a second alignment shape complementary to said first alignment shape, wherein said first end aligns in said mating device connector.

44. The apparatus of claim 44 wherein said AC power supply is at a first voltage and said power conditioner further produces AC power at a second voltage, and said apparatus further comprises at least one lower-voltage AC power receptacle coupled to said power conditioner.

45. The apparatus of claim 44, wherein said mating device connector further comprises at least one of said at least one lower-voltage AC power receptacle coupled to said power conditioner circuit and said power cable comprises at least one pair of AC conducting wires corresponding to said at least one of said least one lower-voltage AC power receptacle, said first cable end further comprises a receptacle corresponding to and coupled to said at least one pair of AC conducting wires, and said second cable end further comprises a receptacle corresponding to and coupled to said at least one pair of AC conducting wires.

46. A computer power supply for supplying power to at least one peripheral device, comprising:
a computer,
a plug coupled to said computer and adapted to receive an AC power supply,
a power conditioner coupled to said plug to convert said AC power supply to a DC power supply and to regulate said DC power supply to a plurality of DC voltages,
a mating device connector comprising a plurality of DC power receptacles coupled to and corresponding to said plurality of DC voltages, and
a power cable, comprising
comprising
a cable comprising a plurality of pairs of conducting wires and having a first end and a second end, wherein said plurality of pairs of conducting wires correspond to said plurality of DC voltages,
a first cable end connected to said first end and comprising a plurality of receptacles corresponding to and coupled to said plurality of pairs of conducting wires, said first cable end adapted to couple to said mating device connector, and
a second cable end connected to said second end and comprising a plurality of receptacles corresponding to and coupled to said plurality of pairs of conducting wires, said second end adapted to fit the peripheral device.

47. The apparatus of claim 46, wherein at least one of said plurality of DC power receptacles is adapted to a first polarity and at least one of said plurality of DC power receptacles is adapted to a second polarity.

48. The apparatus of claim 46, further comprising a connector alignment pin in said mating device connector and a connector alignment pin in said first end, wherein said first end aligns with said mating device connector.

49. The apparatus of claim 46, wherein said mating device connector has a first alignment shape and said first end has a second alignment shape complementary to said first alignment shape, wherein said first end aligns in said mating device connector.

50. The apparatus of claim 46 wherein said AC power supply is at a first voltage and said power conditioner further produces AC power at a second voltage, and said apparatus further comprises at least one lower-voltage AC power receptacle coupled to said power conditioner.

51. The apparatus of claim 50, wherein said mating device connector further comprises at least one of said at least one lower-voltage AC power receptacle coupled to said power conditioner and said power cable comprises at least one pair of AC conducting wires corresponding to said at least one of said least one lower-voltage AC power receptacle, said first cable end further comprises a receptacle corresponding to and coupled to said at least one pair of AC conducting wires, and said second cable end further comprises a receptacle corresponding to and coupled to said at least one pair of AC conducting wires.
